(19) United States
(12) Patent Application Publication
(10) Pub. No.: US 2026/0259075 A1
(43) Pub. Date: Sep. 3, 2026

(54) TANK INTERNAL FLUID AMOUNT ESTIMATION SYSTEM, TANK INFORMATION PROCESSING DEVICE, TANK INTERNAL FLUID AMOUNT ESTIMATION METHOD, AND STORAGE MEDIUM

(71) Applicant: AGC INC., Tokyo (JP)

(72) Inventors: Yoichi SATO, Tokyo (JP); Masato TAKAHASHI, Tokyo (JP); Takuya MINAMI, Tokyo (JP); Yosuke KOBAYASHI, Tokyo (JP)

(73) Assignee: AGC INC., Tokyo (JP)

(21) Appl. No.: 19/653,769

(22) Filed: Apr. 21, 2026

Related U.S. Application Data
(63) Continuation of application No. PCT/JP2024/038408, filed on Oct. 28, 2024.

(30) Foreign Application Priority Data
Oct. 31, 2023 (JP) 2023-187200

(51) Int. Cl. G01F 22/00

(52) U.S. Cl. CPC G01F 22/00

(57) ABSTRACT

Deformation measurement sensors provided at the outer peripheral surface of a cylindrical tank capable of accommodating a predetermined upper limit amount of fluid; a wireless transmission device capable of wirelessly transmitting information related to a detected value of the deformation measurement sensors; a wireless receiving device capable of receiving information related to the detected value of the deformation measurement sensors wirelessly transmitted by the wireless transmitting device; and an estimation unit that estimates whether a fluid amount inside the tank is an amount having any of a plurality of magnitudes including zero and the upper limit amount, based on detected value-related information including a strain amount of the tank based on the detected value of the deformation measurement sensors received by the wireless receiving device, are provided.

### CROSS-REFERENCE TO RELATED APPLICATION

This application is a Continuation of International Application No. PCT/JP2024/038 408, filed Oct. 28, 2024, which claims priority to Japanese Patent Application No. 2023-187200 filed Oct. 31, 2023. Each of the above applications is hereby expressly incorpora ted by reference, in its entirety, into the present application.

### BACKGROUND

### Technical Field

The present disclosure relates to a tank internal fluid amount estimation system, a tank information processing device, a tank internal fluid amount estimation method, and a storage medium.

### Related Art

As disclosed in Japanese Patent Application Laid-Open No. 2021-165148, a cylindrical tank capable of storing a predetermined upper limit amount of fluid is known. As this type of tank, for example, an ISO tank container (UN portable tank) is known, which is a tank based on standards established by the International Organization for Standardization (ISO).

Conventionally, weight measurement devices exist that are capable of measuring the weight of this type of tank. An initial weight, which is the weight of the tank when the amount of fluid in the tank is zero, is obtained in advance, and by comparing a measured value of the weight measurement device with the initial weight, the amount of fluid in the tank can be estimated.

### SUMMARY

The above-described weight measurement device is a large-size device, and it is difficult to transport the weight measurement device over long distances. There are cases in which a filling company, which is a company that fills a tank with a fluid, is different from a user company, which is a company that uses the fluid in the tank, and the filling company and the user company are located in different places. In such cases, the weight measurement device is generally installed at the premises of the filling company. For this reason, it is often not possible to measure the weight of the tank using a weight measurement device at the user company's premises.

Here, if a sensor for measuring the amount of fluid is provided in the tank, the amount of fluid can be detected by this sensor. However, depending on the type of tank filling material, regulations may prohibit the installation of a sensor inside the tank.

The filling company, having received the measurement value of the weight measurement device and the information about the initial weight, can estimate the amount of fluid in the tank. However, in a case in which weight measurement of the tank using a weight measurement device is not performed, the filling company cannot estimate the amount of fluid in the tank. That is, the filling company cannot estimate the amount of fluid in the tank in real time.

In consideration of the foregoing circumstances, the present disclosure aims to provide a tank internal fluid amount estimation system, a tank information processing device, a tank internal fluid amount estimation method, and a storage medium with which a person at a different location from the tank location can ascertain the amount of fluid in the tank in real time without using a large-size weight measurement device or installing sensors inside the tank.

A tank internal fluid amount estimation system according to the present disclosure includes: a deformation measurement sensor that is provided at a cylindrical outer peripheral surface, centered on a predetermined axial line, of a tank that is able to accommodate a predetermined upper limit amount of a fluid, and that detects a deformation amount of the tank; a wireless transmission device that is able to wirelessly transmit information related to a detected value of the deformation measurement sensor; a wireless receiving device that is able to receive the information related to the detected value of the deformation measurement sensor wirelessly transmitted by the wireless transmission device; and an estimation unit that estimates whether a fluid amount inside the tank is an amount having any of a plurality of magnitudes including zero and the upper limit amount, based on detected value-related information including a strain amount of the tank based on the detected value of the deformation measurement sensor received by the wireless receiving device.

A tank information processing device, according to the present disclosure includes: a wireless receiving device that is able to wirelessly receive information related to a detected value of a deformation measurement sensor that is provided at a cylindrical outer peripheral surface, centered on a predetermined axial line, of a tank that is able to accommodate a predetermined upper limit amount of a fluid, and that detects a deformation amount of the tank; and an estimation unit that estimates whether a fluid amount inside the tank is an amount having any of a plurality of magnitudes including zero and the upper limit amount, based on detected value-related information including a strain amount of the tank based on the detected value of the deformation measurement sensor received by the wireless receiving device.

A tank internal fluid amount estimation method according to the present disclosure includes: a step of wirelessly transmitting information related to a detected value of a deformation measurement sensor that is provided at a cylindrical outer peripheral surface, centered on a predetermined axial line, of a tank that is able to accommodate a predetermined upper limit amount of a fluid, and that detects a deformation amount of the tank; a step of receiving the wirelessly transmitted information related to the detected value; and a step of estimating whether a fluid amount inside the tank is an amount having any of a plurality of magnitudes including zero and the upper limit amount, based on detected value-related information including a strain amount of the tank based on the received detected value.

A non-transitory computer-readable storage medium storing a computer program executable by a processor to perform processing comprising: processing of wirelessly receiving information related to a detected value of a deformation measurement sensor that is provided at a cylindrical outer peripheral surface, centered on a predetermined axial line, of a tank that is able to accommodate a predetermined upper limit amount of a fluid; and processing of estimating whether a fluid amount inside the tank is an amount having any of a plurality of magnitudes including zero and the upper limit amount, based on detected value-related information including a strain amount of the tank based on the received detected value.

With the tank internal fluid amount estimation system, tank information processing device, tank internal fluid amount estimation method, and storage medium according to the present disclosure, a person in a different location from the tank location can ascertain the amount of fluid in the tank in real time without using a large-size weight measurement device or installing sensors inside the tank.

### BRIEF DESCRIPTION OF DRAWINGS

FIG. 1 is an overall view of a system for estimating an amount of fluid in a tank according to a first embodiment of the present disclosure.

FIG. 2 is a schematic cross-sectional view of a lower part of a tank.

FIG. 3 is a control block diagram of a control device and a server.

FIG. 4 is a functional block diagram of a control device.

FIG. 5 is a functional block diagram of a server.

FIG. 6 is a block diagram for explaining the operation of the server.

FIG. 7 is an image diagram of machine learning using a random forest.

FIG. 8 is a graph showing relationships between respective parameters and the remaining amount of high-pressure gas.

FIG. 9 is a flowchart showing processing executed by the CPU of the control device.

FIG. 10 is a flowchart showing processing executed by the CPU of the server.

FIG. 11 is a confusion matrix obtained when an estimated remaining amount is obtained using a trained model of the first embodiment.

FIG. 12 is a confusion matrix obtained in a case in which a trained model of a first comparative example is used, which is generated without using detected values and calculated values of an electrothermocouple as training data.

FIG. 13 is a confusion matrix obtained when a trained model of a second comparative example is used, which is generated without using detected values and calculated values of a strain sensor as training data.

FIG. 14 is a graph showing relationships between respective parameters of a second embodiment and the remaining amount of high-pressure gas.

FIG. 15 is a graph showing relationships between respective parameters of a variant example and the remaining amount of high-pressure gas.

FIG. 16 is a graph showing a relationship between continuous predicted values, obtained by applying information related to detected values to a regression model of another variant example, and a continuous actual remaining amount of high-pressure gas in a tank.

### DETAILED DESCRIPTION

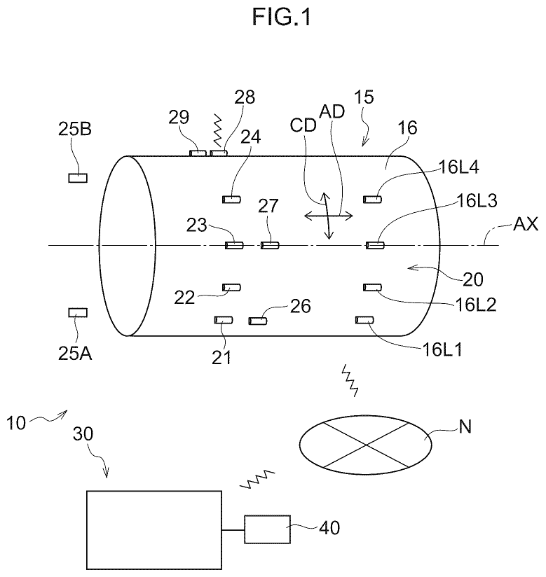

In the following, a tank internal fluid amount estimation system 10 (hereinafter, referred to as the system 10) according to a first embodiment, a tank information processing device, a tank internal fluid amount estimation method, and a storage medium, are explained. As shown in FIG. 1, the system 10 according to the present embodiment includes a tank installation device group 20, a server (tank information processing device) 30, and a display device 40. The tank installation device group 20 and the server 30 are wirelessly intercommunicable via a network N.

First, a tank device 15 at which the tank installation device group 20 is provided is explained. The tank device 15 of the first embodiment is provided within the premises of a user company. Further, the tank device 15 can be mounted on a vehicle (not shown in the drawings) such as a four-wheeled vehicle, and can be moved to various locations using a vehicle.

As shown in FIG. 1, the tank device 15 is provided with a tank 16, which is a cylindrical pressure resistant vessel extending along a central axis AX of the tank device 15. Further, the tank device 15 is further provided with a thermal insulation part (not shown in the drawings) provided at an outer peripheral surface of a tank 16 and a container frame (not shown in the drawings) fixed to the tank 16. The tank device 15 of the first embodiment is an ISO tank container. That is, the tank device 15 is a portable container that can be easily moved to various locations. The interior of the tank 16 can be filled with various types of fluids.

These fluids include liquids and gases. The fluid filled into the tank device 15 of the first embodiment is a high-pressure gas. However, the majority of this high-pressure gas is filled into the tank device 15 in a liquefied state. An inlet part (not shown in the drawings) for introducing high-pressure gas into the tank 16 is provided at the top surface of the tank 16.

The cylindrical shape of the present specification includes a perfectly cylindrical shape and a substantially cylindrical shape. A perfectly cylindrical tank 16 refers to a tank 16 having circular plates formed from flat plates at both end parts in an axial direction (the direction along the central axis AX in FIG. 1), and a portion between these respective end parts that is a cylindrical shape centered on the central axis AX. A substantially cylindrical tank 16 includes, for example, a tank 16 having both end parts in the direction of the central axis AX that are hemispherical, and a portion between these respective end parts that is a cylindrical shape centered on the central axis AX.

As shown in FIG. 1, a 0% line 16L1, a 25% line 16L2, a 50% line 16L3, and a 75% line 16L4 are provided at the outer peripheral surface of the tank 16. The 0% line 16L1 is located at the same position in a vertical direction on the outer peripheral surface of the tank 16 as a lower end position of the inner surface of the tank 16. Here, the volume of the entire internal space of the tank 16 is defined as V. Further, the volume of a region at or below the 0% line 16L1 in the internal space of the tank 16 is defined as V1, the volume of a region at or below the 25% line 16L 2 in the internal space is V2, the volume of a region at or below the 50% line 16L3 in the internal space is V3, and the volume of a region at or below the 75% line 16L4 in the internal space is defined as V4. In this case, V1/V=0, V2/V=0.25, V3/V=0.5, and V4/V=0.75.

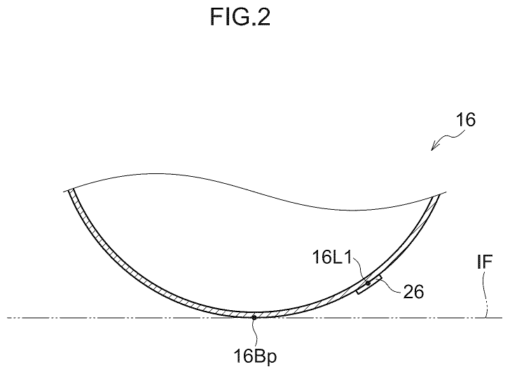

As shown in FIG. 2, the 0% line 16L1 is positioned higher than the lower end position of the outer peripheral surface of the tank 16. When the tank 16 is viewed along its central axis AX, the 0% line 16L1 is positioned higher than the bottom part 16BP, which is the lower end position of the tank 16. The bottom part 16BP is the portion that contacts the installation surface IF in a case in which the tank 16 is assumed to be installed directly on a horizontal installation surface IF.

As shown in FIG. 1, the tank device 15 is provided with the tank installation device group 20. The tank installation device group 20 includes thermocouples (temperature sensors) 21, 22, 23, 24, external air temperature sensors 25A, 25B, strain sensors 26, 27, a control device 28, and a battery 29.

The thermocouples 21, 22, 23, 24 are provided in a row in a vertical direction at the outer peripheral surface of the tank 16. The vertical direction position of the thermocouple 21 is the same as that of the 0% line 16L1, the vertical direction position of the thermocouple 22 is the same as that of the 25% line 16L2, the vertical direction position of the thermocouple 23 is the same as that of the 50% line 16L3, and the vertical direction position of the thermocouple 24 is the same as that of the 75% line 16L4. The thermocouple 21 detects a 0% temperature TC1, which is the temperature of the portion of the outer peripheral surface of the tank 16 to which the thermocouple 21 is fixed, the thermocouple 22 detects a 25% temperature TC2, which is the temperature of the portion of the outer peripheral surface of the tank 16 to which the thermocouple 22 is fixed, the thermocouple 23 detects a 50% temperature TC3, which is the temperature of the portion of the outer peripheral surface of the tank 16 to which the thermocouple 23 is fixed, and the thermocouple 24 detects a 75% temperature TC4, which is the temperature of the portion of the outer peripheral surface of the tank 16 to which the thermocouple 24 is fixed. The thermocouples 21, 22, 23, 24 detect the 0% temperature TC1, the 25% temperature TC2, the 50% temperature TC3, and the 75% temperature TC4, respectively, each time a predetermined time elapses.

The external air temperature sensor 25A detects a first external air temperature TCA, which is an external air temperature of the surroundings of the tank 16, and the external air temperature sensor 25B detects a second external air temperature TCB, which is an external air temperature of the surroundings of the tank 16. The external air temperature sensor 25A and the external air temperature sensor 25B are spaced apart from each other. For example, the external air temperature sensors 25A, 25B are fixed to a container frame.

The strain sensors 26, 27 are provided in a row in the vertical direction at the outer peripheral surface of the tank 16. The strain sensors 26, 27 in the first embodiment are strain gauges. The vertical direction position of the strain sensor 26 is the same as that of the 0% line 16L1, and the vertical direction position of the strain sensor 27 is the same as that of the 50% line 16L3. The strain sensors 26, 27 detect the amount of strain at the portions of the outer peripheral surface of the tank 16 to which they are fixed. This strain amount includes axial direction strain, which is the amount of strain in an axial direction AD, which is a direction parallel to the central axis AX of the tank 16, and circumferential direction strain, which is the amount of strain in a circumferential direction CD around the central axis AX of the tank 16. That is, the strain sensor 26 detects a 0% axial direction strain STx1, which is the axial direction strain at the portion of the outer peripheral surface of the tank 16 to which the strain sensor 26 is fixed, and a 0% circumferential direction strain STcl, which is the circumferential direction strain at this portion. The strain sensor 27 detects a 50% axial direction strain STx3, which is the axial direction strain at the portion of the outer peripheral surface of the tank 16 to which the strain sensor 27 is fixed, and a 50% circumferential direction strain STc3, which is the circumferential direction strain at this portion.

The detected value obtained by the strain sensor 26 is used to obtain the 0% axial direction strain STx1, a 0% axial direction strain correction value STx 1-cr, and a 0% circumferential direction strain correction value STcl-cr, which are important calculated values that are described below.

The strain sensor 26 is not provided at the bottom part 16BP but at the same vertical direction position as the 0% line 16L1. For this reason, as shown in FIG. 2, even in a case in which the bottom part 16BP of the tank 16 is placed on the installation surface IF consisting of a horizontal plane, the strain sensor 26 is distanced from the installation surface IF, upward. For this reason, attachment of the strain sensor 26 to the outer peripheral surface of the tank 16 at the same vertical direction position as the 0% line 16L1, and removal of the strain sensor 26 from this location, are easier than in a case of providing the strain sensor 26 at the bottom part 16BP.

The control device 28 and the battery 29 are fixed to an upper part of the outer peripheral surface of the tank 16.

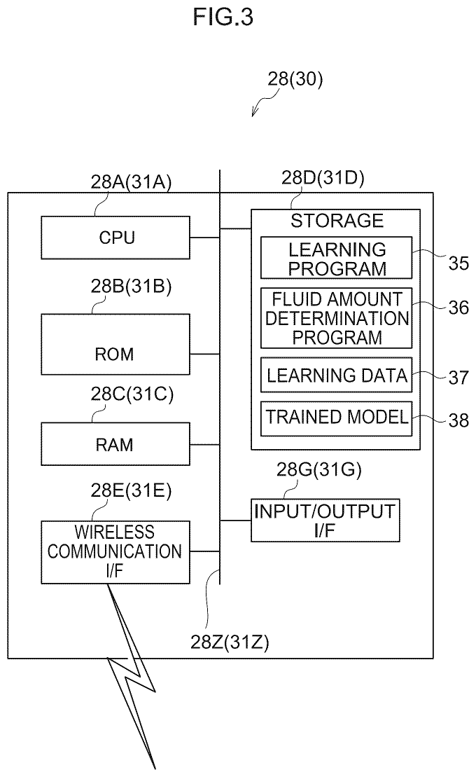

As shown in FIG. 3, the control device 28 includes, as hardware configuration, a central processing unit (CPU; processor) 28A, a read only memory (ROM) 28B, a random access memory (RAM) 28C, a storage 28D, a wireless communication interface (I/F; wireless transmission device) 28E, and an input/output I/F 28G. The CPU 28A, the ROM 28B, the RAM 28C, the storage 28D, the wireless communication I/F 28E, and the input/output I/F 28G are intercommunicably connected via an internal bus 28Z. The CPU 28A can obtain time-related information from a timer.

The CPU 28A is a central computation processing unit that executes various programs (computer programs) and controls respective units. The CPU 28A reads a program from the ROM 28B or the storage 28D, and executes the program employing the RAM 28C as a workspace. The CPU 28A performs control of the respective configurations and performs various types of computing processing in accordance with programs that are stored in the ROM 28B and the storage 28D.

The ROM (storage medium) 28B stores various programs and various data. The RAM 28C temporarily stores programs and data as a workspace.

The storage (storage medium) 28D is configured by a storage device such as a hard disk drive (HDD) or a solid state drive (SSD), and stores various programs and various data.

The wireless communication I/F 28E includes an interface for connecting to the network N. This interface uses the Sigfox (registered trademark) telecommunications standard.

The input/output I/F 28G is connected to various devices. For example, the input/output I/F 28G is connected to the thermocouples 21, 22, 23, 24, the external air temperature sensors 25A, 25B, and the strain sensors 26, 27.

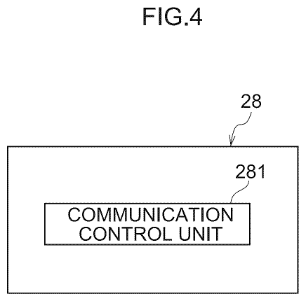

FIG. 4 is a block diagram showing an example of the functional configuration of the control device 28. The control device 28 includes a communication control unit 281. The functions of the communication control unit 281 are realized by the CPU 28A reading and executing a program stored in the ROM 28B or the storage 28D.

The communication control unit 281 controls the wireless communication I/F 28E. The wireless communication I/F 28E can transmit and receive various information. The wireless communication I/F 28E of the first embodiment is capable of performing wireless communication in accordance with the Sigfox (registered trademark) standard.

The wireless communication I/F 28E receives the detected values from each of the thermocouples 21, 22, 23, 24, the external air temperature sensors 25A, 25B, and the strain sensors 26, 27 each time a predetermined time elapses, and information related to each detected value received is wirelessly transmitted to the server 30 (described below) in association with ID information assigned to the tank device 15 and information related to the detection time of each detected value.

The battery 29 is a rechargeable battery. For example, the battery 29 may incorporate plural rechargeable dry cells. The battery 29 can supply electrical power to the strain sensors 26, 27 and the control device 28.

The server 30 of the first embodiment is provided within the premises of the filling company.

As shown in FIG. 3, the server 30 has a hardware configuration including a CPU 31A, a ROM 31B, a RAM 31C, a storage 31D, a wireless communication I/F 31E (wireless receiving device), and an input/output I/F 31G. The CPU 31A, the ROM 31B, the RAM 31C, the storage 31D, the wireless communication I/F 31E, and the input/output I/F 31G are intercommunicably connected via an internal bus 31Z. The functions of the CPU 31A, ROM 31B, RAM 31C, storage 31D, wireless communication I/F 31E, input/output I/F 31G, and internal bus 31Z, are the same as the functions of the CPU 28A, ROM 28B, RAM 28C, storage 28D, wireless communication I/F 28E, input/output I/F 28G, and internal bus 28Z, respectively.

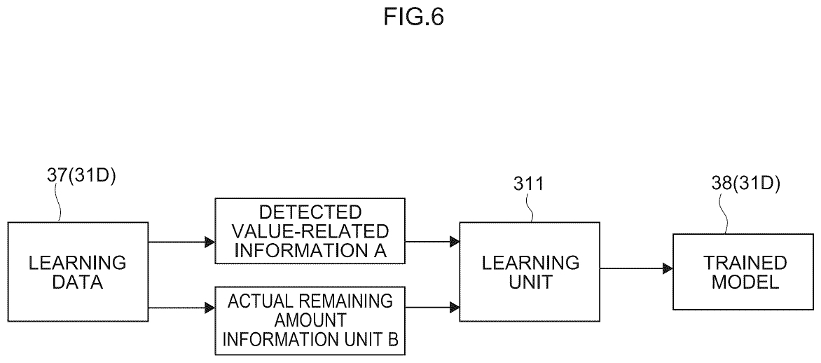

As shown in FIG. 3, the storage 31D stores an operating system including a learning program 35 and a fluid amount determination program 36. Furthermore, the storage 31D stores learning data 37 and a trained model 38. Here, as shown in FIG. 6, detected value-related information A, which is described below, and information regarding the actual remaining amount (fluid amount) of high-pressure gas in the tank 16, are stored in the learning data 37. Here, the information regarding the remaining amount of high-pressure gas is information indicating whether the ratio of the remaining amount of high-pressure gas in the tank 16 to the volume V of the total internal space of the tank 16 is either zero percent or 100% (upper limit amount). Here, this zero percent includes both exactly zero percent and a magnitude that can be said to be substantially zero percent. Substantially zero percent refers, for example, to a magnitude of 1% or less. Further, 100% includes both exactly 100% and a magnitude that can be said to be substantially 100%. Substantially 100% percent refers, for example, to a magnitude of 99% or more. Further, the information relating to the actual remaining amount of high-pressure gas in the tank 16 is referred to as “actual remaining amount information B”. The tank 16 of a test tank device 15 used when acquiring the learning data 37 is provided with a level gauge. The actual remaining amount information B is obtained using this level gauge. For example, if the test tank device 15 is installed at the user company's premises, the actual remaining amount information B is wirelessly transmitted from the control device 28 (wireless communication I/F 28E) to the server 30 (wireless communication I/F 30E). The trained model 38 is described below.

The wireless communication I/F 31E includes an interface for connecting to the network N. This interface uses the Sigfox (registered trademark) telecommunications standard.

The input/output I/F 31G is connected to various devices. For example, the input/output I/F 31G is connected to a display device 40.

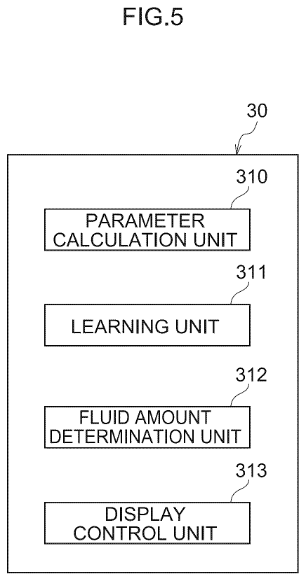

FIG. 5 is a block diagram showing an example of the functional configuration of the server 30. The server 30 includes a parameter calculation unit 310, a learning unit 311, a fluid amount determination unit (estimation unit) 312, and a display control unit 313. The functions of the parameter calculation unit 310, the learning unit 311, the fluid amount determination unit 312, and the display control unit 313 are realized by the CPU 31A reading and executing programs stored in the ROM 31B or the storage 31D. More specifically, the CPU 31A reads out the learning program 35 from the storage 31D and executes it, thereby realizing the learning unit 311, and the CPU 31A reads out the fluid amount determination program 36 from the storage 31D and executes it, thereby realizing the fluid amount determination unit 312.

The parameter calculation unit 310 calculates, based on the detected values from the thermocouples 21, 22, 23, 24, the external air temperature sensors 25A, 25B, and the strain sensors 26, 27 received by the wireless communication I/F 31E, the average external temperature TCav, the 0% correction temperature TC1-cr, the 25% correction temperature TC2-cr, the 50% correction temperature TC3-cr, the 75% correction temperature TC4-cr, the 0% axial direction strain correction value (strain correction value) STx1-cr, the 0% circumferential direction strain correction value (strain correction value) STc1-cr, the 50% circumferential direction strain correction value (strain correction value) STc3-cr, the 0% strain difference amount correction value (strain correction value) STxc1-cr, and the 50% strain difference amount correction value (strain correction value) STxc3-cr.

The parameter calculation unit 310 calculates the average external air temperature TCav, which is the average value of the first external air temperature TCA and the second external air temperature TCB. That is, the average external temperature TCav=(first external temperature TCA +second external temperature TCB)/2.

Furthermore, the parameter calculation unit 310 calculates the 0% correction temperature TC1-cr, which is the value obtained by subtracting the average external air temperature TCav from the 0% temperature TC1. That is, the 0% correction temperature TC1-cr=0% temperature TC1−average external air temperature TCav.

Furthermore, the parameter calculation unit 310 calculates the 25% correction temperature TC2-cr, which is the value obtained by subtracting the average external air temperature TCav from the 25% temperature TC2. That is, the 25% correction temperature TC2-cr=25% temperature TC2- average external air temperature TCav.

Furthermore, the parameter calculation unit 310 calculates the 50% correction temperature TC3-cr, which is the value obtained by subtracting the average external air temperature TCav from the 50% temperature TC3. That is, the 50% correction temperature TC3-cr=50% temperature TC3−average external air temperature TCav.

Furthermore, the parameter calculation unit 310 calculates the 75% correction temperature TC4-cr, which is the value obtained by subtracting the average external air temperature TCav from the 75% temperature TC4. That is, the 75% correction temperature TC4-cr=75% temperature TC4- average external air temperature TCav.

Furthermore, the parameter calculation unit 310 calculates the 0% axial direction strain correction value STx1-cr and a 0% circumferential direction strain correction value STc1-cr. The 0% axial direction strain correction value STx1-cr is a value obtained by subtracting the axial direction strain (strain correction amount DTx) of the entire tank 16, caused by the average external air temperature TCav, from the 0% axial direction strain STx1. That is, the 0% axial direction strain correction value STx1-cr=0% axial direction strain STx1−strain correction amount DTx. The 0% circumferential direction strain correction value STc1-cr is a value obtained by subtracting the circumferential direction strain (strain correction amount DTc) of the entire tank 16, caused by the average external air temperature TCav, from the 0% circumferential direction strain STc1. That is, the 0% circumferential direction strain correction value STc1-cr=0% circumferential direction strain STel-strain correction amount DTc.

Furthermore, the parameter calculation unit 310 calculates the 50% axial direction strain correction value STx3-cr and the 50% circumferential direction strain correction value STc3-cr. The 50% axial direction strain correction value STx3-cr is a value obtained by subtracting the strain correction amount DTx from the 50% axial direction strain STx3. That is, the 50% axial direction strain correction value STx3-cr=50% axial direction strain STx3 strain correction amount DTx. The 50% circumferential direction strain correction value STc3-cr is a value obtained by subtracting the circumferential direction strain (strain correction amount DTc) of the entire tank 16, caused by the average external air temperature TCav, from the 50% circumferential direction strain STc3. That is, the 50% circumferential direction strain correction value STc3-cr=50% circumferential direction strain STc3-strain correction amount DTc.

Furthermore, the parameter calculation unit 310 calculates the 0% strain difference amount correction value STxc1-cr. The 0% strain difference amount correction value STxc1-cr is the absolute value of the difference amount between the 0% axial direction strain correction value STx1-cr and the 0% circumferential direction strain correction value STc1-cr. That is, the 0% strain difference amount correction value STxc1-cr=|0% axial direction strain correction value STx1-cr -0% circumferential direction strain correction value STc1-cr |.

Furthermore, the parameter calculation unit 310 calculates the 50% strain difference amount correction value STxc3-cr. The 50% strain difference amount correction value STxc3-cr is the absolute value of the difference amount between the 50% axial direction strain STx3 minus the axial direction strain (strain correction amount DTx) of the entire tank 16 caused by the average external air temperature TCav, and the 50% circumferential direction strain correction value STc3-cr. That is, the 50% strain difference amount correction value STxc3-cr=|(50% axial direction strain STx3−strain correction amount Dtx)−50% circumferential direction strain correction value STc3-cr |.

In the following explanation, the average external air temperature TCav, the 0% correction temperature TC1-cr, the 25% correction temperature TC2-cr, the 50% correction temperature TC3-cr, the 75% correction temperature TC4-cr, the 0% axial direction strain correction value STx1-cr, the 0% circumferential direction strain correction value STc1-cr, the 50% axial direction strain correction value STx3-cr, the 50% circumferential direction strain correction value STc3-cr, the 0% strain difference amount correction value STxc1-cr, and the 50% strain difference amount correction value STxc3-cr calculated by the parameter calculation unit 310 may be referred to as the “calculated values”.

Hereinafter, information relating to each of the above-described detected values and information relating to the calculated values may be collectively referred to as the “detected value-related information A”. The detected value-related information A is recorded in the storage 31D. At this time, each of the above-described detected values is recorded in the storage 31D in association with ID information and information related to the detection time of each detected value, and the calculated values are recorded in the storage 31D in association with ID information and information related to the calculation time of each calculated value.

As shown in FIG. 6, the learning unit 311 has the function of generating a trained model 38 in which the detected value-related information A and the actual remaining amount information B are associated with each other by performing machine learning using the detected value-related information A and the actual remaining amount information B included in the learning data 37 stored in the storage 31D as training data.

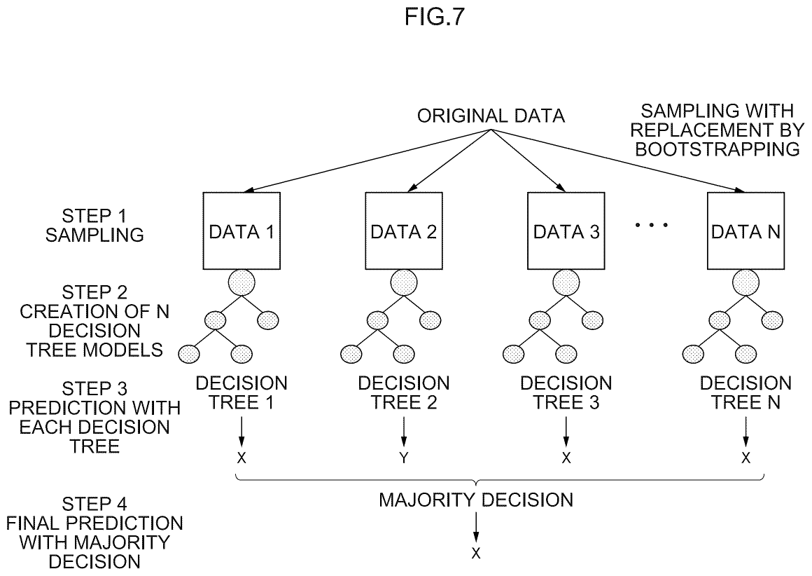

The trained model 38 of the first embodiment is generated using a random forest. That is, the trained model 38 is generated by ensemble learning (for example, bagging) using plural decision trees (see FIG. 7). These decision trees are input with the estimation information A as an explanatory variable and these decision trees output the actual remaining amount information B as a response variable. That is, the response variable is information indicating whether the actual remaining amount of high-pressure gas is either 0% or 100%.

The fluid amount determination unit 312 calculates an “estimated remaining amount” using the generated trained model 38 and detected value-related information A that is different from the training data. That is, the fluid amount determination unit 312 applies the detected value-related information A to the learned model 38 and obtains the estimated remaining amount at the time at which the applied detected value-related information A was detected (calculated). This estimated remaining amount is information indicating whether the proportion of the remaining amount of high-pressure gas in the tank 16 estimated by the fluid amount determination unit 312 is either 0% or 100%. That is, the trained model 38 of the first embodiment is a binary classification model.

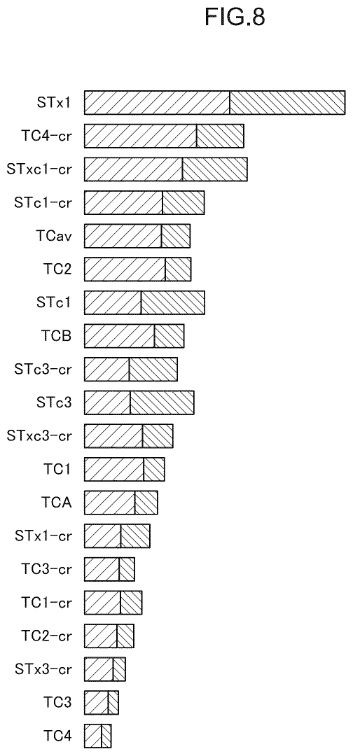

Since a random forest is used when generating the trained model 38, the fluid amount determination unit 312 can recognize the importance of each parameter included in the detected value-related information A. That is, simultaneously with generating the trained model 38 using a random forest, data representing the relationship between each parameter shown in FIG. 8 and the actual remaining amount information B (the importance of the parameter) is obtained. The hatched portions on the right side of each graph in FIG. 8 represent the relationship between each parameter and the proportion of the remaining amount of high-pressure gas being 0%, and the hatched portions on the left side of each graph indicate the relationship between each parameter and the remaining amount of high-pressure gas being 100%. The longer the length of the graph, the greater the relevance of the parameter. For example, the parameter 0% axial direction strain STx1 increases the probability that the remaining amount of high-pressure gas is predicted to be 100% by approximately just under 0.06. As is clear from FIG. 8, among the parameters, the 0% axial direction strain STx1, the 75% correction temperature TC4-cr, and the 0% strain difference amount correction value STxc1-cr have a particularly high correlation with the proportion of the remaining amount of high-pressure gas being 0% or 100%.

The respective detected values and the above-described calculated values obtained from the thermocouples 21, 22, 23, 24, the external air temperature sensors 25A, 25B, and the strain sensors 26, 27 are presumed to have a correlation with the remaining amount of high-pressure gas in the tank 16.

That is, the pressure exerted on the tank 16 by the high-pressure gas causes the tank 16 to deform. Therefore, it is thought that there is a correlation between the detected values and calculated values of the strain sensors 26, 27 and the remaining amount of high-pressure gas in the tank 16.

Further, the tank 16 experiences thermal strains that do not have a direct correlation with the amount of high-pressure gas remaining in the tank 16. Therefore, when estimating the remaining amount of high-pressure gas in the tank 16 based on the amount of strain on the tank 16, it is necessary to eliminate the influence of this thermal strain. For this reason, it is thought that there is an indirect correlation between the detected values and calculated values of the thermocouples 21, 22, 23, 24 and the remaining amount of high-pressure gas in the tank 16.

Further, the detected values of the external air temperature sensors 25A, 25B also influence the thermal strain. That is, it is presumed that the detected values of the external air temperature sensors 25A, 25B also have some correlation with the remaining amount of high-pressure gas in the tank 16.

The display control unit 313, by controlling the display device 40, causes the display device 40 to display the estimated remaining amount acquired by the fluid amount determination unit 312. For example, in a case in which the fluid amount determination unit 312 estimates that “the ratio of the remaining amount of high-pressure gas in the tank 16 to the volume V of the tank 16 is 0%”, the display control unit 313 causes the display device 40 to display characters representing the estimation result. Further, in a case in which the fluid amount determination unit 312 estimates that “the ratio of the remaining amount of high-pressure gas in the tank 16 to the volume V of the tank 16 is 100%”, the display control unit 313 causes the display device 40 to display characters representing the estimation result.

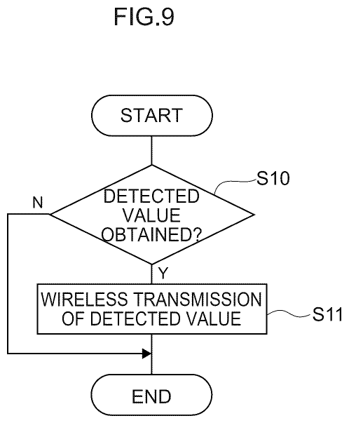

Next, the operation of the system 10 is described. First, the operation of the CPU 28A of the control device 28 is explained with reference to the flowchart of FIG. 9. The CPU 28A repeatedly executes the processing of the flowchart of FIG. 9 each time a predetermined time elapses.

In step S10 (hereinbelow, the word “step” is omitted), the CPU 28A determines whether or not a detected value has been acquired.

When the determination in S10 is “Yes”, the CPU 28A proceeds to S11 and wirelessly transmits the detected value to the server 30.

When the processing of S11 is completed or when the determination in S10 is “No”, the CPU 28A ends the processing of the flowchart of FIG. 9 for the time being.

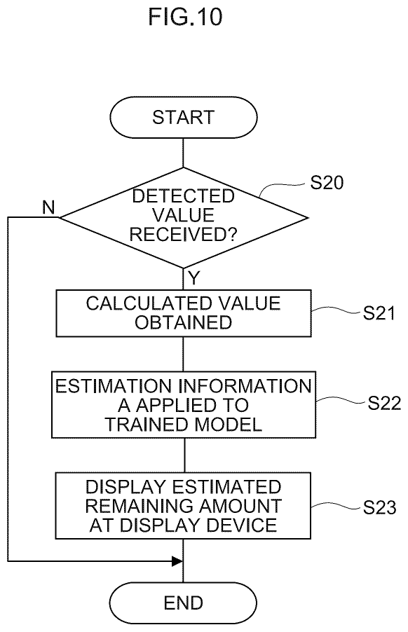

Next, the operation of the CPU31A of the server 30 is explained with reference to the flowchart of FIG. 10. The CPU 31A repeatedly executes the processing of the flowchart of FIG. 10 each time a predetermined time elapses.

In S20, the CPU 31A determines whether or not a detected value has been received from the control device 28.

If the determination in S20 is “Yes”, the CPU 31A proceeds to S21, and obtains a calculated value using the received detected value.

After completing the processing of S21, the CPU 31A proceeds to S22, applies the detected value-related information A including the detected value and the calculated value to the trained model 38, and obtains information regarding the estimated remaining amount.

After completing the processing of S22, the CPU 31A proceeds to S23 and causes the display device 40 to display information regarding the estimated remaining amount.

When the processing of S23 is completed or when the determination in S20 is “No”, the CPU 31A ends the processing of the flowchart of FIG. 10 for the time being.

As explained above, the system 10 of the first embodiment, using the detected value-related information A including information related to detected values received by the server 30 from the control device 28, estimates whether the ratio of the remaining amount of high-pressure gas in the tank 16 to the volume V of the tank 16 is 0% or 100%. For this reason, by using the system 10, a person at a filling company's premises, at a different location from the user company's premises, can ascertain in real time whether the ratio of the remaining amount of high-pressure gas in the tank 16 to the volume V of the tank 16 is 0% or 100% without using a large-size weight measurement device or installing sensors inside the tank.

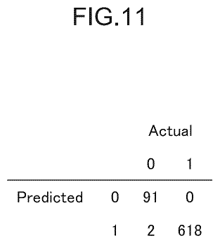

Additionally, the system 10 utilizes machine learning to determine the estimated remaining amount. FIG. 11 shows a confusion matrix obtained when the estimated remaining amount is obtained by applying the detected value-related information A to the trained model 38 of the first embodiment. In FIG. 11, “0” indicates that the estimated remaining amount is 0%, and “1” indicates that the estimated remaining amount is 100%. As is clear from FIG. 11, by using the trained model 38, it is possible to ascertain with high accuracy in real time whether the ratio of the remaining amount of high-pressure gas in the tank 16 is 0% or 100%. Therefore, the system 10 can determine the estimated remaining amount with higher accuracy than in a case in which machine learning is not used.

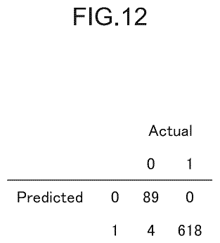

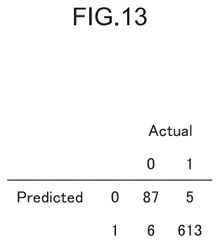

FIG. 12 is a confusion matrix in a case of using a trained model 38 of a first comparative example generated without using the detected values of the thermocouples 21, 22, 23, 24 and the external air temperature sensors 25A, 25B or the calculated values based on these detected values as training data. FIG. 13 is a confusion matrix in a case of using a trained model 38 of a second comparative example generated without using the detected values of the strain sensors 26, 27 and the external air temperature sensors 25A, 25B or the calculated values based on these detected values as training data. By comparing FIG. 11 with FIGS. 12 and 13, it was confirmed that the estimation accuracy of the estimated remaining amount in a case of using the trained model 38 of the first embodiment was more favorable than the estimation accuracy of the first comparative example or the second comparative example.

Further, as is clear from FIG. 8, the 0% axial direction strain STx1, the 75% correction temperature TC4-cr, the 0% strain difference amount correction value STxc1-cr, the 0% circumferential direction strain correction value STc1-cr, and the average external temperature TCav are important parameters for estimating whether the ratio of the remaining amount of high-pressure gas in the tank 16 to the volume V of the tank 16 is either 0% or 100%. In particular, the 0% axial direction strain STx1, the 75% correction temperature TC4-cr, and the 0% strain difference amount correction value STxc1-cr are extremely important items of information. That is, the detected value of the strain sensor 26 is extremely important information. The system 10 uses these items of information to determine the estimated remaining amount. For this reason, the system 10 can estimate the remaining amount with high accuracy.

Provision of the strain sensor 26 at the 0% line 16L1 and the thermocouple 24 at the 75% line 16L4, and provision of the external air temperature sensors 25A, 25B is very closely related to being able to obtain the extremely important parameters that are the 0% axial direction strain STx1, the 75% correction temperature TC4-cr, and the 0% strain difference amount correction value STxc1-cr.

Further, if a trained model for binary classification is created using only, for example, the 0% axial direction strain STx1, the 75% correction temperature TC4-cr, and the 0% axial direction strain correction value STx1-cr, and this trained model is used to obtain the estimated remaining amount, the calculation load on the CPU 31 can be reduced.

Further, by using the 0% axial direction strain STx1, the 75% correction temperature TC4-cr, and the 0% strain difference amount correction value STxc1-cr in combination, the estimated remaining amount can be estimated with high accuracy.

Furthermore, the control device 28 provided at the tank device 15 uses the power of a battery 29 provided at the tank device 15 to wirelessly transmit the detected value to the server 30. For this reason, regardless of the place at which the tank device 15 is located, a person at the filling company's premises can ascertain the estimated remaining amount.

Furthermore, since the control device 28 and the wireless communication I/F 31E perform communication with the Sigfox (registered trademark) standard, the control device 28 can perform wireless communication with a server 30 (wireless communication I/F 31E) located at a great distance from the control device 28 with little power consumption.

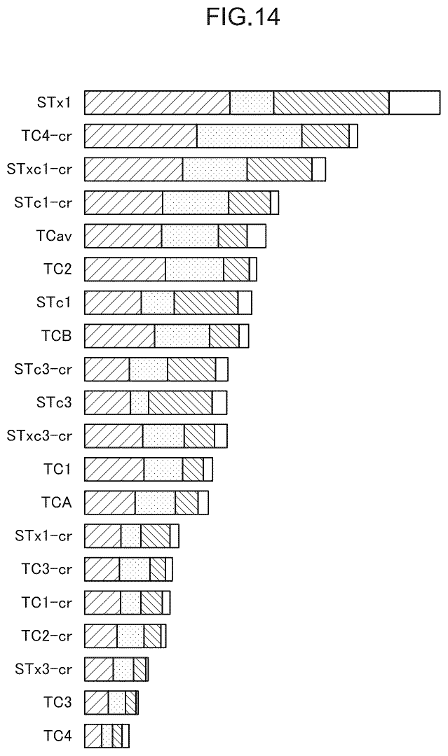

Next, a second embodiment of the present disclosure is explained with reference to FIG. 14. Here, the same configurations as those in the first embodiment are denoted by the same reference numerals, and detailed description thereof is omitted.

The characteristic of the second embodiment is generation of a trained model 38 of a four-value classification model in which the detected value-related information A and the actual remaining amount information B are associated with each other by having a learning unit 311 perform machine learning using the detected value-related information A and the actual remaining amount information B included in the learning data 37 stored in the storage 31D.

The trained model 38 of the second embodiment is also generated using a random forest. That is, the trained model 38 is generated by ensemble learning by bagging using plural decision trees.

The fluid amount determination unit 312 of the second embodiment also calculates an “estimated remaining amount” using the generated trained model 38 and detected value-related information A that is different from the training data. This estimated remaining amount is information indicating whether the proportion of the remaining amount of high-pressure gas in the tank 16 estimated by the fluid amount determination unit 312 is any of 0%, 25%, 75% or 100%. This zero percent includes both exactly zero percent and a magnitude that can be said to be substantially zero percent as discussed above, and this 100% includes both exactly 100% and a magnitude that can be said to be substantially 100% as discussed above. Further, 25% includes both exactly 25% and a magnitude that can be said to be substantially 25%. Substantially 25% percent refers, for example, to a magnitude from 24% to 26%. Further, 75% includes both exactly 75% and a magnitude that can be said to be substantially 75%. Substantially 75% percent refers, for example, to a magnitude from 74% to 76%.

Since, in the second embodiment, too, a random forest is used when generating the trained model 38, the fluid amount determination unit 312 can recognize the importance of each parameter included in the detected value-related information A. That is, at the same time as generating the trained model 38 using the random forest, data representing the relationship between each parameter shown in FIG. 14 and the actual remaining amount information B is obtained. The hatched portion in the second region from the right in each graph in FIG. 14 represents the relationship between each parameter and the proportion of the remaining amount of high-pressure gas being 0%, and the hatched portion in the region at the far-left side in each graph represents the relationship between each parameter and the proportion of the remaining amount of high-pressure gas being 100%. Further, the white portion that is the region at the far-right side of each graph represents the relationship between each parameter and the proportion of the remaining amount of high-pressure gas being 25%. The polka-dot portion, which is the second region from the left in each graph, represents the relationship between each parameter and the proportion of the remaining amount of high-pressure gas being 75%. The longer the length of the graph, the greater the relevance of the parameter. As is clear from FIG. 14, among the respective parameters, the 0% axial direction strain STx1, the 75% correction temperature TC4-cr, and the 0% strain difference amount correction value STxc1-cr have a particularly strong correlation with the remaining proportion of high-pressure gas being 0%, being 25%, being 75%, and being 100%.

The display control unit 313 causes the display device 40 to display the estimated remaining amount obtained by the fluid amount determination unit 312. In a case, for example, in which the fluid amount determination unit 312 estimates that “the ratio of the remaining amount of high-pressure gas in the tank 16 to the volume V of the tank 16 is 25%”, the display control unit 313 causes the display device 40 to display characters representing the estimation result. Further, in a case in which the fluid amount determination unit 312 estimates that “the ratio of the remaining amount of high-pressure gas in the tank 16 to the volume V of the tank 16 is 75%”, the display control unit 313 causes the display device 40 to display characters representing the estimation result.

As explained above, the system 10 of the second embodiment, using the detected value-related information A including information related to detected values received by the server 30 from the control device 28, estimates whether the ratio of the remaining amount of high-pressure gas in the tank 16 to the volume V of the tank 16 is 0%, 25%, 75% or 100%.

Therefore, a person at the filling company's premises can ascertain in real time whether the ratio of the remaining amount of high-pressure gas in the tank 16 to the volume V of the tank 16 is 0%, 25%, 75% or 100% without using a large-size weight measurement device or installing sensors inside the tank.

Therefore, a person at the filling company's premises who sees the display device 40 performing display that “the ratio of the remaining amount of high-pressure gas in the tank 16 to the volume V of the tank 16 is 25%” can recognize that tank 16 will soon need to be refilled with high pressure gas.

Further, a person at the filling company's premises who sees the display device 40 performing display that “the ratio of the remaining amount of high-pressure gas in the tank 16 to the volume V of the tank 16 is 75%” can recognize that there is little need to refill the tank 16 with high pressure gas at this time.

While the confusion matrix is omitted, by using the trained model 38 of the second embodiment, it is possible to recognize with high accuracy in real time whether the proportion of the remaining amount of high-pressure gas in the tank 16 is 0% or 25%. Therefore, the system 10 can determine the estimated remaining amount with higher accuracy than in a case in which machine learning is not used. Here, while the confusion matrix is not shown in the drawings, it was also confirmed that it was possible to estimate with high accuracy whether the proportion of the remaining amount of high-pressure gas in the tank 16 was 75% or 100%.

Further, as is clear from FIG. 14, the 0% axial direction strain STx1, the 75% correction temperature TC4-cr, the 0% strain difference amount correction value STxc1-cr, the 0% circumferential direction strain correction value STc1-cr, and the average external temperature TCav are important parameters for estimating whether the ratio of the remaining amount of high-pressure gas in the tank 16 to the volume V of the tank 16 is any of 0%, 25%, 75% or 100%. In particular, the 0% axial direction strain STx1, the 75% correction temperature TC4-cr, and the 0% strain difference amount correction value STxc1-cr are extremely important items of information. That is, the detected value of the strain sensor 26 is extremely important information. The system 10 uses these items of information to determine the estimated remaining amount. For this reason, the system 10 can estimate the remaining amount with high accuracy.

Further, if a trained model for four-value classification is created using only, for example, the 0% axial direction strain STx1, the 75% correction temperature TC4-cr, and the 0% axial direction strain correction value STx1-cr, and an estimated remaining amount is calculated using this trained model, the calculation load on the CPU 31 can be reduced.

The first and second embodiments explained above indicate examples of the content of the present disclosure, and may be combined with other known techniques, or part of the configuration may be omitted or modified within a range that does not depart from the gist of the present disclosure.

For example, while the systems 10 of the first and second embodiments perform binary classification and four-value classification, the system 10 may perform three-value classification or five-or higher-value classification. For example, the system 10 may perform three-value classification that estimates whether the ratio of the remaining amount of high-pressure gas in the tank 16 relative to the volume V of the tank 16 is any of 0%, 50%, or 100%.

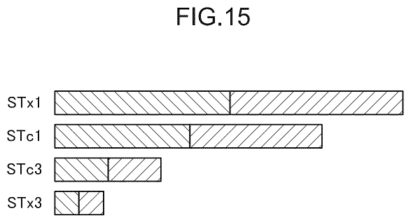

Further, the detected value-related information A may include only information related to the detected values of the strain sensors 26, 27. In such a case, the leaming unit 311 generates a trained model 38 in which the detected value-related information A and the actual remaining amount information B are associated with each other by performing machine learning using the detected value-related information A (the detected values of the strain sensors 26, 27) and the actual remaining amount information B included in the learning data 37 stored in the storage 31D as training data. FIG. 15 shows data representing the relationship between each parameter and the actual remaining amount information B, which is obtained at the same time as generating a binary classification trained model 38 using a random forest. As is clear from FIG. 12, even in a case in which this binary classification trained model 38 is used, it is possible to recognize with comparatively high accuracy in real time whether the proportion of the remaining amount of high-pressure gas in the tank 16 is 0% or 100%. However, compared to the first embodiment, the accuracy of estimating the remaining amount of high-pressure gas in this variant example is slightly lower.

Further, the CPU 31A (fluid amount determination unit 312) of the server 30 may obtain the estimated remaining amount based on the detected value-related information A without using machine learning (the trained model 38). For example, a map (not shown) that defines the relationship between the 0% axial direction strain STx1, which is the most important parameter for determining whether the ratio of the remaining amount of high-pressure gas in the tank 16 to the volume V of the tank 16 is 0%, 25%, 75%, or 100%, and the ratio of the actual remaining amount of high-pressure gas in the tank 16 to the volume V of the tank 16 may be stored in the ROM 31B or the storage 31D, and the CPU 31A may obtain the estimated remaining amount based on this map and the 0% axial direction strain STx1.

Further, as the argument of the map, different detected value-related information A from the 0% axial direction strain STx1 may be used. For example, the 75% correction temperature TC4-cr and the 0% strain difference amount correction value STxc1-cr may be applied to a map having, as arguments, the 75% correction temperature TC4-cr, the 0% strain difference amount correction value STxc1-cr, and the ratio of the actual remaining amount of high-pressure gas in the tank 16 to the volume V of the tank 16, and the estimated remaining amount obtained.

As mentioned above, the 0% axial direction strain STx1 is the most important parameter. For this reason, in a case in which the CPU 31 A uses either machine learning or a map, it is also preferable that the CPU 31A obtains the estimated remaining amount using the 0% axial direction strain STx1.

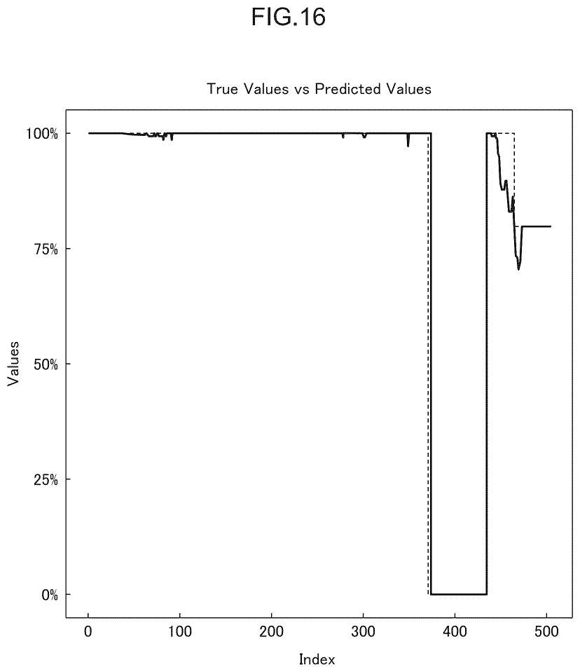

Furthermore, the learning unit 311 of the second embodiment may generate a regression model (trained model) using training data for generating the trained model 38 of the second embodiment. FIG. 16 shows continuous predicted values (dotted line) obtained by applying the detected value-related information A to this regression model, and the continuous actual remaining amount of high-pressure gas in the tank 16 (solid line). The horizontal axis of the graph in FIG. 16 represents time, and the vertical axis represents the proportion of the remaining amount of high-pressure gas in the tank 16. In this case, the root mean squared error (MRSE) related to the predicted value and the actual remaining amount was 1.31, the mean absolute error (MAE) was 0.20, and r² (R-squared: coefficient of determination) was 0.94. As is clear from the analysis results, by using this regression model, by utilizing the detected value-related information A at a given time, the specific proportion of the remaining amount of high-pressure gas in the tank 16 at this given time can be estimated with high accuracy.

The lines set on the outer peripheral surface of the tank 16 may be different lines from the 0% line 16L1, the 25% line 16L2, the 50% line 16L3, and the 75% line 16L4. For example, in addition to the 0% line 16L1, a 30% line, a 60% line, and a 90% line may be set on the outer peripheral surface of the tank 16. In this case, thermocouples are respectively provided at the same vertical positions as the 0% line 16L1, the 30% line, the 60% line, and the 90% line. In this case, for example, a trained model can be used to perform a four-value classification to estimate whether the ratio of the remaining amount of high-pressure gas in the tank 16 to the volume V of the tank 16 is any of 0%, 30%, 60%, or 90%.

The fluid may be a liquid or may include a liquid and a gas.

A deep neural network may be applied as the trained model. Further, backpropagation may be used to generate this trained model.

The communication standard for wireless communication of the system 10 may be a different communication standard from Sigfox (registered trademark).

Here, in the respective embodiments described above, various types of processors other than a CPU may execute the various processing that the CPU executes by reading out software (programs). Examples of such processors include a programmable logic device (PLD) in which circuit configuration can be modified post-manufacture, such as a field-programmable gate array (FPGA), or a specialized electric circuit that is a processor with a specifically-designed circuit configuration for executing specific processing, such as an application specific integrated circuit (ASIC). Further, the processing may be executed by one of these various types of processors, or may be executed by combining two or more of the same type or different types of processors (e.g., plurals FPGAs, or a combination of a CPU and an FPGA, or the like). Alternatively, some or all of the plural operations performed by specific plural processors in the respective embodiments described above may be integrated and executed by a single processor. Further, a hardware configuration of the various processors is, more specifically, formed as an electric circuit combining circuit elements such as semiconductor elements. Further, in each of the above-described embodiments, aspects have been explained in which a processing program is pre-stored (installed) in a storage; however, there is no limitation thereto. The programs may be provided in a format stored in a non-transitory storage medium such as compact disc read only memory (CD-ROM), digital versatile disc read only memory (DVD-ROM), or universal serial bus (USB) memory. Further, the program may be provided in a format downloaded from an external device through a network.

The control device 28 may transmit the respective above-mentioned detected values to a cloud server, and the cloud server may have a parameter calculation unit 310, a learning unit 311, and a fluid amount determination unit 312. Furthermore, the cloud server may transmit information relating to the estimated remaining amount determined by the fluid amount determination unit 312 to the server 30 via wireless communication.

The tank of the present disclosure (ISO tank container; UN portable tank) is preferably used as a container for using and preserving (including storing) refrigerants used in refrigeration equipment and the like. In particular, this system is useful in the case of large-size containers such as an ISO tank container.

A deformation measurement sensor that is different from the strain sensor may be used to acquire the amount of strain (axial direction strain, circumferential direction strain) at a predetermined portion of the tank 16. One example of this kind of deformation measurement sensor is a camera. An image of the outer peripheral surface of the tank 16 acquired by the camera may be analyzed to obtain the amount of strain at a predetermined portion of the tank 16.

One of two respectively different servers (devices; computers, CPUs) may have a learning unit as a functional configuration, and the other may have a fluid amount determination unit (estimation unit) as a functional configuration. That is, the other server may use the learned model and the detected value-related information A acquired by the one server to determine the estimated remaining amount.

The program of the present disclosure can be provided as a program product. A program product includes any aspect of a product for providing the program. For example, the program product includes a program provided over a network such as the Internet, and a non-transitory computer-readable recording medium such as a CD-ROM or DVD on which the program is stored.

1. A tank internal fluid amount estimation system, comprising:
a deformation measurement sensor that is provided at a cylindrical outer peripheral surface, centered on a predetermined axial line, of a tank that is able to accommodate a predetermined upper limit amount of a fluid, and that detects a deformation amount of the tank;
a wireless transmission device that is able to wirelessly transmit information related to a detected value of the deformation measurement sensor;
a wireless receiving device that is able to receive the information related to the detected value of the deformation measurement sensor wirelessly transmitted by the wireless transmission device; and
an estimation unit that estimates whether a fluid amount inside the tank is an amount having any of a plurality of magnitudes including zero and the upper limit amount, based on detected value-related information including a strain amount of the tank based on the detected value of the deformation measurement sensor received by the wireless receiving device.

2. The tank internal fluid amount estimation system of claim 1, comprising a temperature sensor provided at the outer peripheral surface of the tank, wherein:
the wireless transmission device is able to wirelessly transmit information related to a detected value of the temperature sensor,
the wireless receiving device is able to receive the information related to the detected value of the temperature sensor wirelessly transmitted by the wireless transmission device, and
the estimation unit estimates the fluid amount inside the tank based on the detected value-related information, which includes a temperature of the tank based on the detected value of the temperature sensor received by the wireless receiving device, and the strain amount.

3. The tank internal fluid amount estimation system of claim 2, wherein the detected value-related information includes a strain correction value, being a value obtained by subtracting, from the strain amount, a strain correction amount that is a strain amount of the tank resulting from an external air temperature in a vicinity of the tank.

4. The tank internal fluid amount estimation system of claim 1, wherein the estimation unit estimates the fluid amount inside the tank by inputting the detected value-related information received by the wireless receiving device into a trained model generated based on the detected value-related information and an actual fluid amount in the tank.

5. The tank internal fluid amount estimation system of claim 4, wherein the deformation measurement sensor is provided at the outer peripheral surface of the tank at a same position in a vertical direction as a lower end position of an inner surface of the tank.

6. The tank internal fluid amount estimation system of claim 4, wherein the detected value-related information includes a 0% axial direction strain that is an axial direction strain of the tank detected by the deformation measurement sensor, which is provided at a same position in a vertical direction as a lower end position of an inner surface of the tank.

7. The tank internal fluid amount estimation system of claim 1, wherein the wireless transmission device operates using electric power of a battery provided at the tank.

8. The tank internal fluid amount estimation system of claim 1, wherein the estimation unit estimates whether the fluid amount inside the tank is any of zero, the upper limit value, 25% of the upper limit value, or 75% of the upper limit value.

9. A tank information processing device, comprising:
a wireless receiving device that is able to wirelessly receive information related to a detected value of a deformation measurement sensor that is provided at a cylindrical outer peripheral surface, centered on a predetermined axial line, of a tank that is able to accommodate a predetermined upper limit amount of a fluid, and that detects a deformation amount of the tank; and
an estimation unit that estimates whether a fluid amount inside the tank is an amount having any of a plurality of magnitudes including zero and the upper limit amount, based on detected value-related information including a strain amount of the tank based on the detected value of the deformation measurement sensor received by the wireless receiving device.

10. A tank internal fluid amount estimation method, comprising:
a step of wirelessly transmitting information related to a detected value of a deformation measurement sensor that is provided at a cylindrical outer peripheral surface, centered on a predetermined axial line, of a tank that is able to accommodate a predetermined upper limit amount of a fluid, and that detects a deformation amount of the tank;
a step of receiving the wirelessly transmitted information related to the detected value; and
a step of estimating whether a fluid amount inside the tank is an amount having any of a plurality of magnitudes including zero and the upper limit amount, based on detected value-related information including a strain amount of the tank based on the received detected value.

11. A non-transitory computer-readable storage medium storing a computer program executable by a processor to perform processing comprising;
processing of wirelessly receiving information related to a detected value of a deformation measurement sensor that is provided at a cylindrical outer peripheral surface, centered on a predetermined axial line, of a tank that is able to accommodate a predetermined upper limit amount of a fluid; and
processing of estimating whether a fluid amount inside the tank is an amount having any of a plurality of magnitudes including zero and the upper limit amount, based on detected value-related information including a strain amount of the tank based on the received detected value.
